(19) United States
(12) Patent Application Publication
(10) Pub. No.: US 2009/0109135 A1
(43) Pub. Date: Apr. 30, 2009

(54) DISPLAY APPARATUS

(76) Inventors: Yoshihisa OOISHI, Yokohama (JP); Junichi Maruyama, Yokohama (JP); Takashi Shoji, Fujisawa (JP); Kikuo Ono, Mobara (JP); Yuki Okada, Tama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/261,206

(22) Filed: Oct. 30, 2008

(30) Foreign Application Priority Data
Oct. 30, 2007 (JP) 2007-281271

(51) Int. Cl. G09G 3/20

(52) U.S. Cl. 345/55

(57) ABSTRACT

To reduce moving image blurring with a simple circuit while an image quality of a still image is maintained, a display apparatus emphasizes and deemphasizes a change in display data along a temporal direction based upon preceding frame data and current frame data, emphasizes and deemphasizes a change in the emphasized and deemphasized display data along a spatial direction, and displays, with respect to a portion where the display data has been changed between frames, an image in which the change in display data is emphasized along both the temporal direction and the spatial direction, and another image in which the change in display data is deemphasized along both the temporal direction and the spatial direction within one rendering frame period.

### CROSS-REFERENCE TO RELATED APPLICATION

The present application claims priority from Japanese application JP 2007-281271 filed on Oct. 30, 2007, the content of which is hereby incorporated by reference into this application.

### BACKGROUND OF THE INVENTION

1. Field of the Invention

The present invention relates to a display apparatus, and more specifically, to a display apparatus which realizes a reduction of moving image blurring that occurs when a moving image is displayed by employing a simple circuit, while a display quality of a still image is not deteriorated.

2. Description of the Related Art

Display apparatuses (hereinafter, also referred to as “displays”) are mainly classified to impulse response type displays and hold response type displays when those display apparatuses are classified in view of, especially, displaying of moving images. The above-mentioned impulse response display is such a type of display in which a luminance response is lowered immediately after scanning, which is similar to afterglow characteristics represented in CRTs. In contrast to the impulse response type display, the above-mentioned hold response type display is such a type of display in which luminance produced based upon display data is continuously held until the next scanning, which is similar to display characteristics of liquid crystal displays (LCDs).

As features of the hold response type display, when a still image is displayed, a superior display quality without flickering can be achieved. However, when a moving image is displayed, so-called “moving image blurring” may occur, namely, a circumferential portion of a moving object is blurred, and hence a display quality of the moving image is considerably deteriorated. The moving image blurring is caused by a so-called “retina afterimage”. That is, when a line of sight (LOS) of a viewer is moved in connection with movement of an object, the viewer interpolates display images before and after the movement with respect to a displayed image with the held luminance. As a result, even if a response speed of a hold response type display is improved in higher degrees, it is known that the moving image blurring cannot be completely solved. In order to solve this problem, a method described below is known as an effective solving method. That is, a displayed image is updated at shorter frequency, or a black screen is inserted so as to once cancel a retina afterimage, whereby a hold response type display is approximated to an impulse response type display.

On the other hand, a television receiver has been typically proposed as a display apparatus which is required to display moving images. Scanning frequencies of the television receiver have been standardized. For example, in an NTSC signal, an interlaced scanning frequency of 60 Hz is selected, whereas in a PAL signal, a sequential scanning frequency of 50 Hz is selected. When a frame frequency of a displayed image is selected to be 60 Hz to 50 Hz based upon this frequency, since the frequency is not so high, the moving image blurring may occur.

As means for improving the above-mentioned moving image blurring, JP 2005-6275 A discloses a technology for updating images at the above-mentioned shorter frequency. JP 2005-6275 A discloses a method of increasing a scanning frequency, and increasing updating speed of an image by producing display data of an interpolated frame based upon the display data between frames (hereinafter, abbreviated as “interpolated frame producing method”). Further, as a technical idea for inserting a black frame, JP 2003-280599 A discloses a technology of inserting black display data between the display data.

However, in the method disclosed in JP 2005-6275 A, display data which is not originally present is produced. If more precise data is to be produced, then the circuit scale is increased. Conversely, if the circuit scale is reduced, then a mistake in producing the interpolated frame may occur. Thus, there may be a risk that the display quality is considerably lowered.

On the other hand, in the method disclosed in JP 2003-280599 A, since there is a luminance difference between the black frame and the video frame, if the frequency is low, then the flickering maybe observed. As a result, this conventional method is difficult to be applied to television receivers operated in the PAL system.

As another solving method, JP 2006-259689 A discloses a method for reducing the moving image blurring by employing a simple circuit. That is, JP 2006-259689 A describes such an image display method in which, while a frame frequency of input image signal is multiplied by an integer, a new image signal is produced in the increased frames, and then, an image is displayed by employing the input image signal and the produced image signal. The above-mentioned conventional image display method includes: linear-summing continuous input image signals so as to produce a primary intermediate image signal; filtering the primary intermediate image signal by a low-pass filter so as to produce a secondary intermediate image signal; extracting only a secondary intermediate image signal which corresponds to a varied region of the continuous input image signals so as to produce a tertiary intermediate image signal; extracting only an image signal located in a non-varied region of the continuous input image signals so as to produce a common image signal; and synthesizing the tertiary intermediate image signal with the common image signal so as to produce a produced image signal.

The conventional image display method disclosed in JP 2006-259689 A may be realized by employing the simpler circuit, as compared with the conventional interpolated frame producing method disclosed in JP 2005-6275 A, but this image display method has the following problems.

As a first problem, it is assumed that video data of increased frames is determined in accordance with an averaged value between frames. However, the produced video data is not always the optimum video data, depending upon the cut-off frequency of the low-pass filter. In addition, generally speaking, response times of a display apparatus employing liquid display elements are selected to be milliseconds, and the response times vary according to tone level. As a consequence, there may be a risk that stable reducing effects may not be achieved with respect to the moving image blurring.

As a second problem, the tertiary intermediate image signal is synthesized with the common image signal. However, the synthesized image portion does not always have continuities, but the synthesized image may contain the high frequency component. When this high frequency component is moved, this moved image portion may be visually recognized as a blurred image portion. As a consequence, there may be a risk that the satisfactory reducing effects cannot be achieved with respect to the moving image blurring.

As a third problem, the display apparatus alternately displays the produced image signal and the input image signal. In this case, with respect to the produced image, the averaging process is performed along the temporal direction, and the low-pass filtering process is performed along the spatial direction. However, since no data conversion is carried out with respect to the input image signal, there may be a risk that the satisfactory reducing effects cannot be achieved with respect to the moving image blurring.

### SUMMARY OF THE INVENTION

The present invention has been made in view of the above-mentioned problems, and therefore has an object to provide a display apparatus capable of reducing moving image blurring with a higher effect by employing a simple circuit.

In order to clarify the inventive idea of the present invention, a time period during which display data for one screen is transferred from an external system is defined as one input frame period, whereas another time period during which display data for one screen of a matrix type display is rewritten is defined as one rendering frame period. In the case of JP 2006-259689 A described above, one input frame period is constituted by two rendering frame periods.

The display apparatus of the present invention includes a memory for storing display data for at least one input frame. The display data is read from the memory at a speed which is “n” times higher than an input frame frequency, while symbol “n” is an integer equal to or higher than 1, and then, display data for two frames are produced which are synchronized with each other. When n=1, display data of a current frame need not be read from the memory. Further, since display data of a preceding frame is utilized as comparison data in order to check a change, all bits contained in the display data of the preceding frame are not required. Note that one case of n=2 is exemplified in a first embodiment of the present invention, and another case of n=1 is exemplified in a second embodiment.

In the display apparatus of the present invention, both converting display data for two frames in such a manner that a change in display data of proximate pixels thereof along a temporal direction is emphasized based upon the above-mentioned change along the temporal direction, and converting the display data in such a manner that a change in the display data of the proximate pixels thereof along a spatial direction is emphasized based upon the above-mentioned change in the spatial direction are performed within one rendering frame period. Any of those two steps may be carried out first. The first embodiment exemplifies such an example that the emphasizing step along the temporal direction is carried out first, and the emphasizing step along the spatial direction is carried out next. A third embodiment exemplifies such an example that the emphasizing step along the spatial direction is carried out first, and the emphasizing step along the temporal direction is carried out next.

In a next (m−1) rendering frame period, converting the display data in such a manner that a change in the display data of the proximate pixels along the temporal direction is deemphasized based upon the change along the temporal direction, and converting the display data in such a manner that a change in the display data of the proximate pixels along the spatial direction is deemphasized based upon the change along the spatial direction are carried out within the above-mentioned (m−1) rendering frame period.

On the other hand, in such a case where display data is not changed between input frames, the input display data is utilized as data for rendering without being converted. A cycle period during which the same calculations are performed constitutes “m” rendering frame periods. Since moving image blurring occurs dominantly in one rendering frame period, it is preferable to set that the frequency thereof is selected to be 50 Hz through 60 Hz or higher, which correspond to the normal one rendering frame period. In the case where the cycle period becomes further long, there is a possibility that a difference between an emphasized frame and a deemphasized frame may be visually recognized as a judder. As a result, it is desirable that the repetition frequency is selected to be equal to or higher than 24 Hz, which has been employing in movies and the like, because, at this repetition frequency, the above-mentioned possibility that the difference is visually recognized as the judder (vibration of image) may be neglected in human vision.

When the above-mentioned inventive idea of the present invention is applied, since none of display data for a still image portion is converted, image qualities similar to those of the conventional method can be maintained. With respect to a moving image portion, contour portions of one rendering frame along the temporal direction and the spatial direction are visually recognized within one rendering frame among (m×n) rendering frames. As a result, the moving image blurring may be reduced, and hence the moving image can be displayed with higher image quality.

### BRIEF DESCRIPTION OF THE DRAWINGS

These and other features, objects and advantages of the present invention will become more apparent from the following description when taken in conjunction with the accompanying drawings wherein:

FIG. 1 is a block diagram illustrating configuration of a display apparatus according to a first embodiment of the present invention;

FIG. 2 is a block diagram illustrating configuration of a calculating circuit employed in the display apparatus of FIG. 1;

FIG. 3 is a timing chart representing flows of data on a frame basis in the display apparatus according the first embodiment of the present invention;

FIG. 4 is a flow chart for describing operations executed in a temporal direction data converting circuit employed in the display apparatus of FIG. 1;

FIG. 5 is a flow chart for describing operations executed in a spatial direction data converting circuit employed in the display apparatus of FIG. 1;

FIG. 6 is a conceptual diagram illustrating a data conversion performed in the first embodiment of the present invention;

FIGS. 7A and 7B are tables indicating setting examples of calculation parameters employed in the first embodiment of the present invention;

FIGS. 8A and 8B are diagrams for describing an example of a converted image in displaying a moving image in the first embodiment of the present invention;

FIGS. 9A and 9B are diagrams for describing an effect of improvement of a moving image quality obtained in the display apparatus according to the first embodiment of the present invention;

FIG. 10 is a diagram for describing a relationship between conversion data and a temporal direction data coincident flag according to the first embodiment of the present invention;

FIG. 11 is a block diagram illustrating configuration of a display apparatus according to a second embodiment of the present invention;

FIG. 12 is a timing chart representing flows of data on a frame basis in the display apparatus according to the second embodiment of the present invention;

FIG. 13 is a block diagram illustrating configuration of a calculating circuit employed in a display apparatus according to a third embodiment of the present invention; and

FIG. 14 is a conceptional diagram illustrating a data conversion performed in the third embodiment of the present invention.

### DETAILED DESCRIPTION OF THE INVENTION

A basic idea of a display apparatus according to the present invention is given as follows. That is, assuming now that a current frame is a frame “M”, a change in display data along a temporal direction is emphasized and deemphasized based upon input display data of a frame “M−1” (namely, the frame preceding the current frame “M”) and input display data of the current frame “M”, and further, a change in display data along a spatial direction is emphasized and deemphasized. Specifically, images displayed in pixels changed in their video contents between now and preceding input frame and vicinal pixels thereof are emphasized along both the temporal direction and the spatial direction within one rendering frame period and are deemphasized along both the temporal direction and the spatial direction within one preceding rendering frame period therewith. A total of the rendering frame periods falls within one input frame period.

### First Embodiment

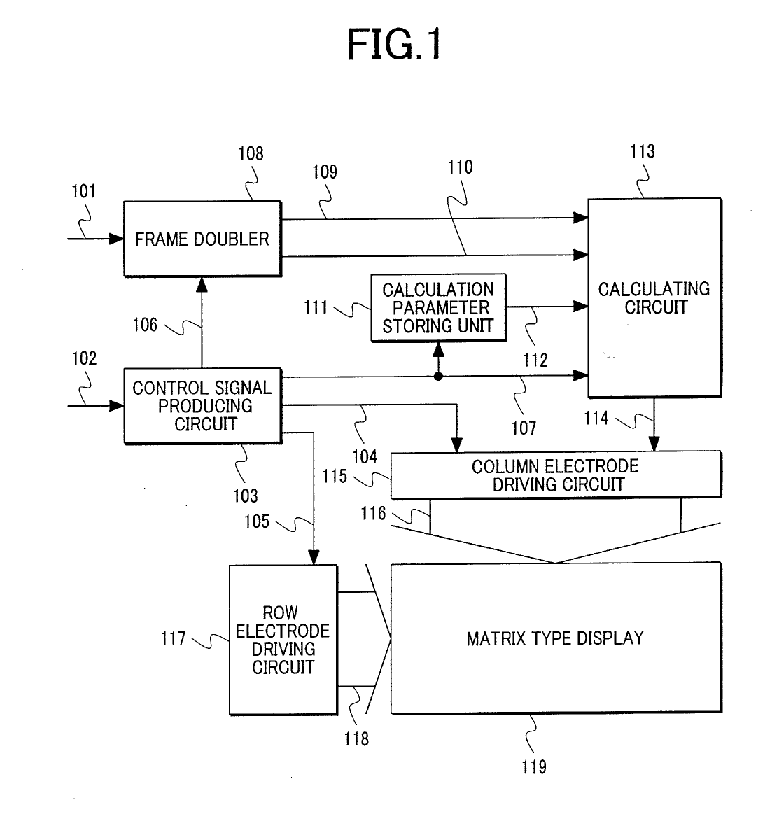

Referring now to FIGS. 1 to 10, a description is made of a first embodiment of the present invention in such a case where one input frame is driven within two rendering frames. FIG. 1 is a block diagram illustrating configuration of a display apparatus according to a first embodiment of the present invention. In FIG. 1, reference numeral 101 denotes input display data, and reference numeral 102 denotes an input control signal. It is assumed that both the input display data 101 and the input control signal 102 are input from an external system (not shown) (namely, display signal source such as host computer and video signal processing circuit). Reference numeral 103 denotes a control signal producing circuit; 104, a column electrode control signal; 105, a row electrode control signal; 106, a memory control signal; and 107, a calculation control signal.

It is also assumed that the above-mentioned control signals 104 to 107 are produced based upon the input control signal 102 in the control signal producing circuit 103. Further, reference numeral 108 denotes a frame doubler; 109, current frame display data; and 110, preceding frame display data. In the frame doubler 108, the input display data 101 is written based upon the memory control signal 106, and also, the input display data 101 is read two times at a double speed with respect to a time period (frame period) from a display region head of a certain screen of this input display data to a display region head of a subsequent screen thereof.

In this case, it is assumed that, with respect to one input frame period, a time period during which an image of the input frame is displayed based upon a first half of read data is referred to as “first half field”, whereas another time period during which an image of the input frame is displayed based upon a second half of read data is referred to as “second half field” hereinafter. Further, it is assumed that the current frame display data 109 and the proceeding frame display data 110 have a phase difference of one frame. Reference numeral 111 denotes a calculation parameter storing unit, and reference numeral 112 denotes a calculation parameter. In the calculation parameter storing unit 111, calculation parameters stored there into are read based upon the calculation control signal 107. Reference numeral 113 denotes a calculating circuit, and reference numeral 114 denotes time/space conversion display data. Reference numeral 115 denotes a column electrode driving circuit; 116, a column electrode drive signal; 117, a row electrode driving circuit; and 118, a row electrode drive signal. Reference numeral 119 denotes a matrix type display constituted by display elements along the row direction and the column direction.

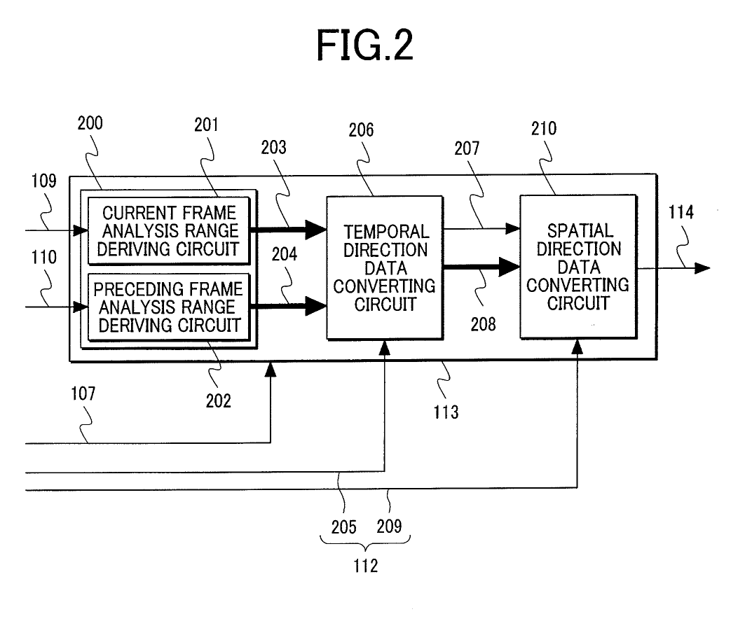

FIG. 2 is a block diagram illustrating configuration of the above-mentioned calculating circuit 113 illustrated in FIG. 1. Reference numeral 200 denotes a frame analysis range deriving circuit; 201, a current frame analysis range deriving circuit; and 202, a preceding frame analysis range deriving circuit. The calculation parameter 112 is constituted by parameters 205 and 209 described below. That is, reference numeral 205 denotes a temporal direction calculation parameter, and reference numeral 209 denotes a spatial direction calculation parameter. Both the calculation parameters 205 and 209 are stored in the calculation parameter storing unit 111 of FIG. 1. Further, reference numeral 109 denotes the current frame display data, and reference numeral 110 denotes the preceding frame display data. Reference numeral 203 denotes current frame analysis range deriving display data; 204, current frame deriving display data; 206, a temporal direction data converting circuit; 207, a temporal direction data coincident flag; 208, temporal direction conversion data; 210, a spatial direction data converting circuit; and 114, the time/space conversion display data.

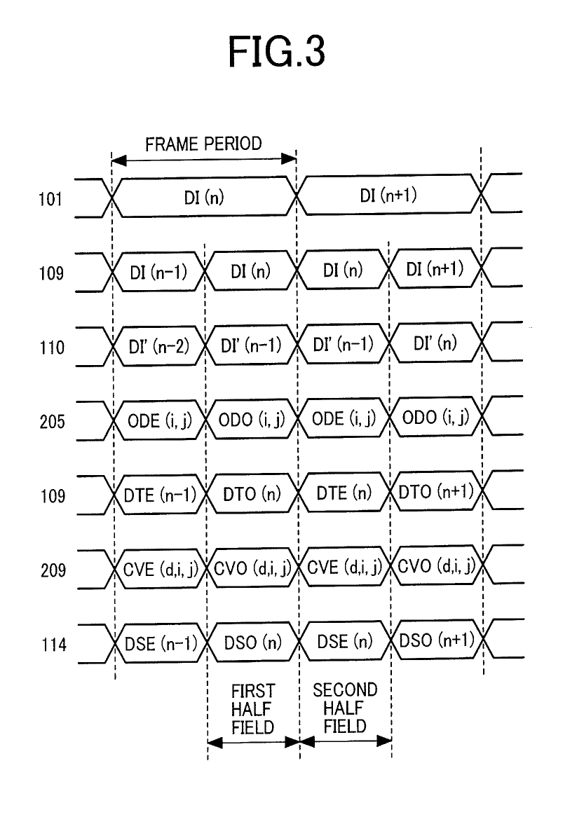

FIG. 3 is a chart representing a timing relationship under such a condition that display data is input to the display apparatus according to the first embodiment, and then, the display data is input to the column electrode driving circuit 115. In this timing chart, the input display data 101 of an “n”th frame is expressed as “DI(n)”. In the current frame display data 109, it is so indicated that a data portion expressed by “DI(n)” is equal to “DI(n)” in the input display data 101. In the preceding frame display data 110, it is so indicated that a data portion expressed by “DI(n)” is equal to the above-mentioned data portion “DI(n)” in the input display data 101, or corresponds to such a data portion in which the bit number of the display data is reduced.

In the temporal direction calculation parameter 205, it is assumed that a symbol “ODO(i, j)” denotes a temporal direction data calculation parameter in the first half field, and a symbol “ODE(i,j)” denotes a temporal direction data calculation parameter in the second half field. In the temporal direction conversion data 208, it is so indicated that a data portion “DTO(n)” is temporal direction conversion data in the first half field in the “n”th frame, and a data portion “DTE(n)” is temporal direction conversion data in the second half field in the “n”th frame.

In the spatial direction calculation parameter 209, it is so indicated that a symbol “CVO(d,i,j)” denotes a spatial direction calculation parameter in the first half field, and a symbol “CVE(d,i,j)” denotes a spatial direction calculation parameter in the second half field. In the time/space conversion display data 114, it is so indicated that a data portion “DSO(n)” is time/space conversion display data in the first half field in the “n”th frame, and a data portion “DSE(n)” is time/space conversion display data in the second half field in the “n”th frame.

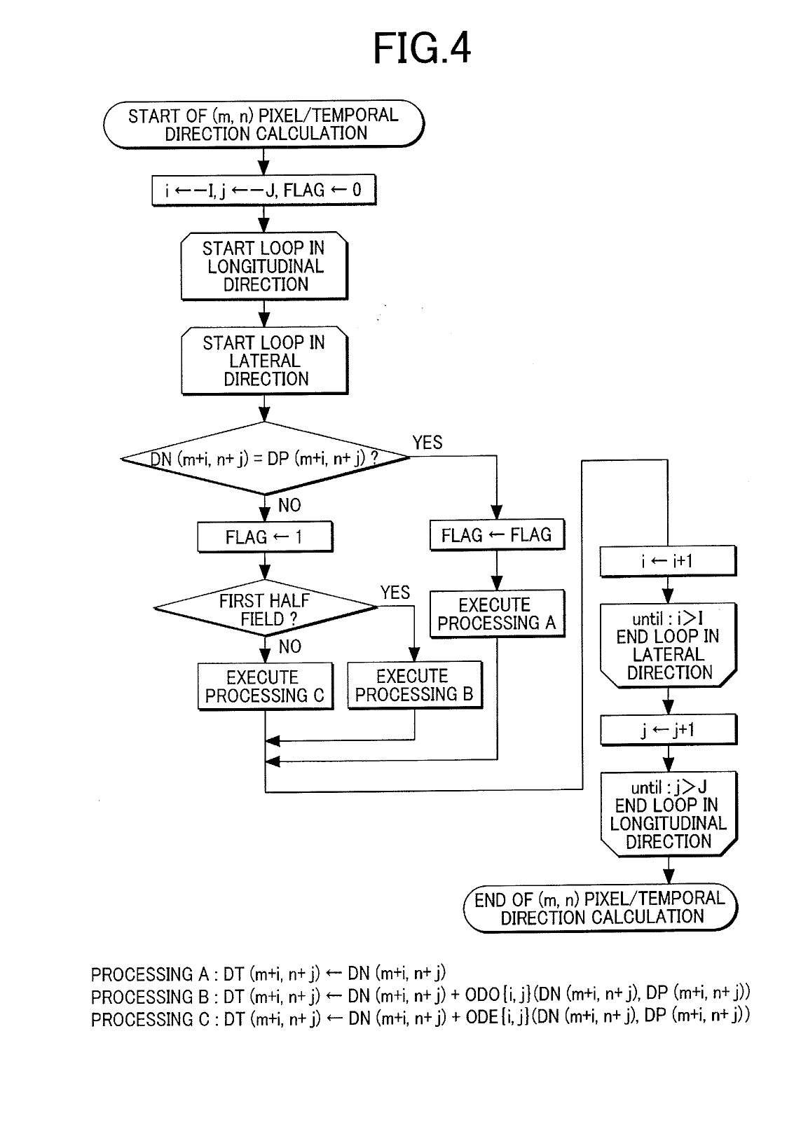

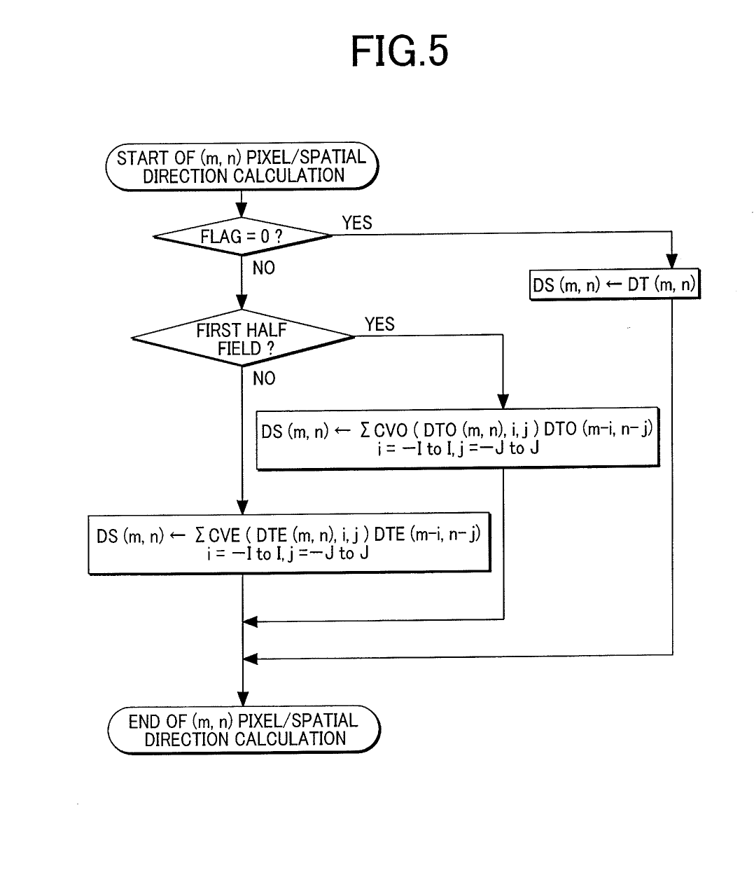

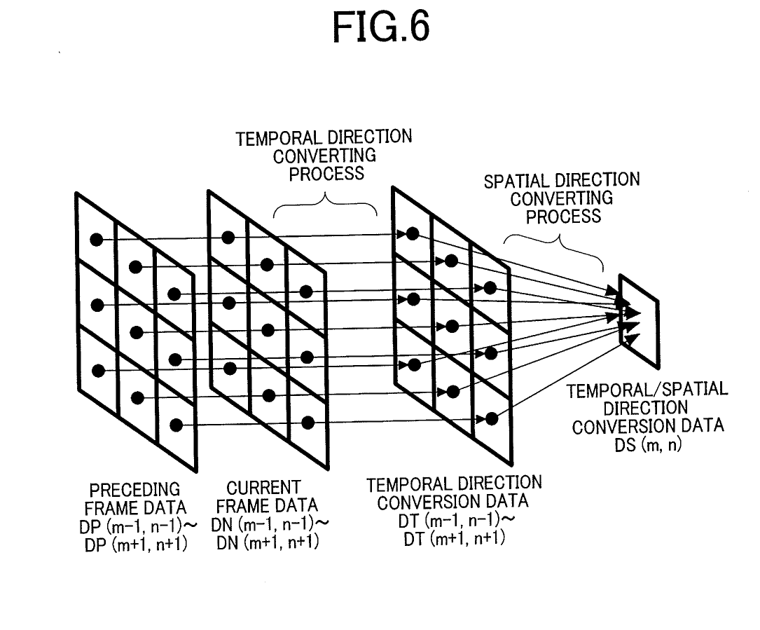

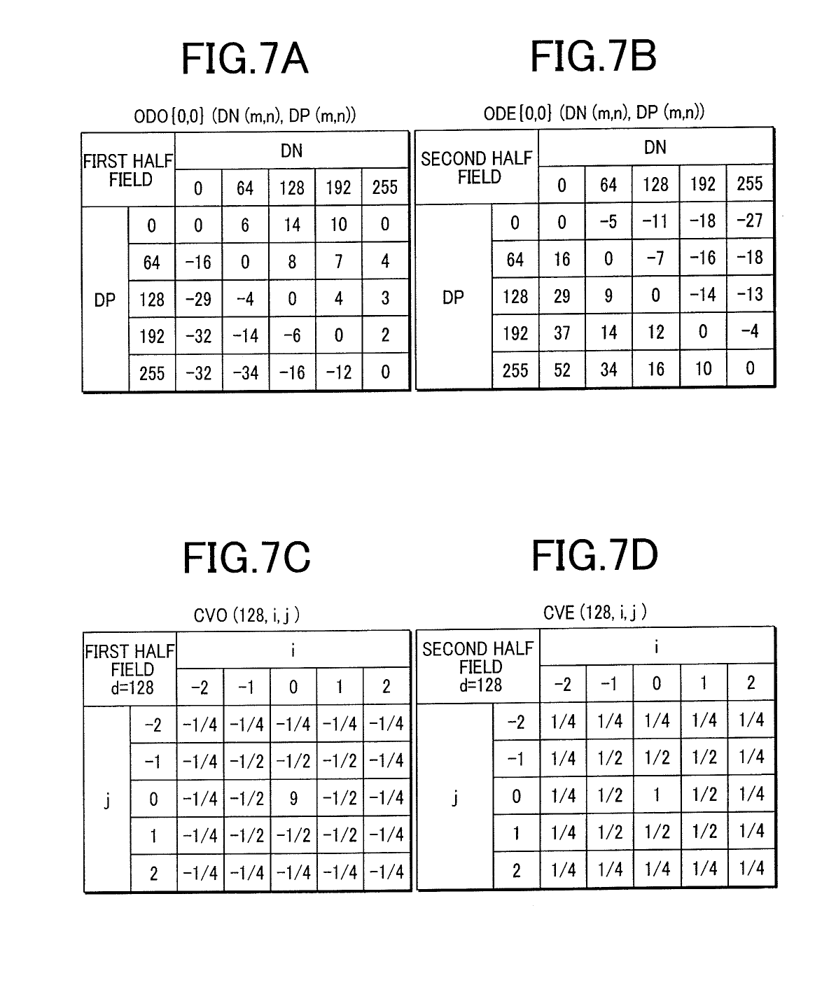

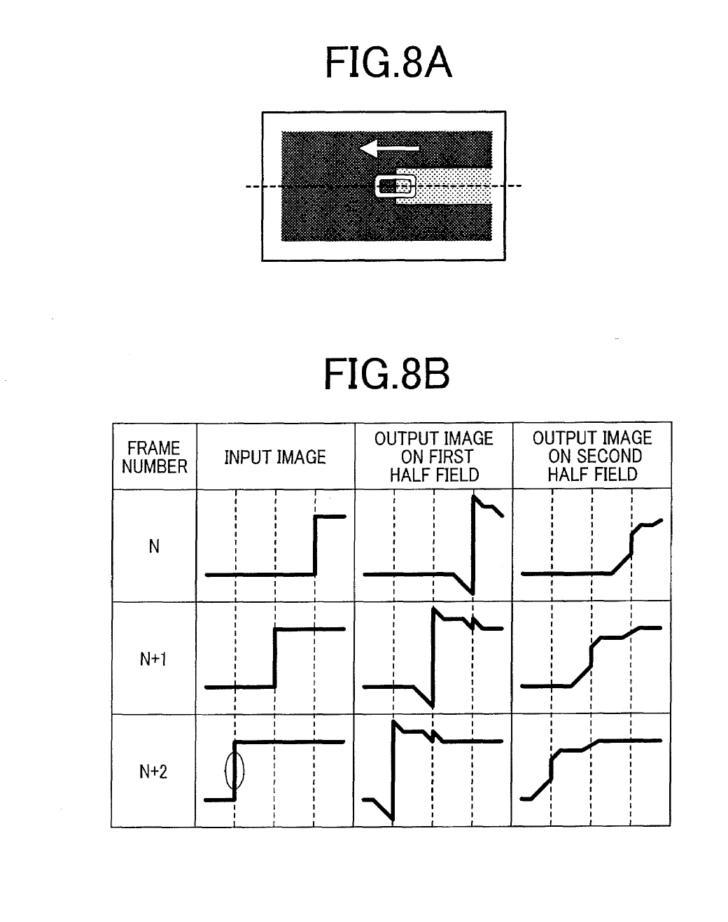

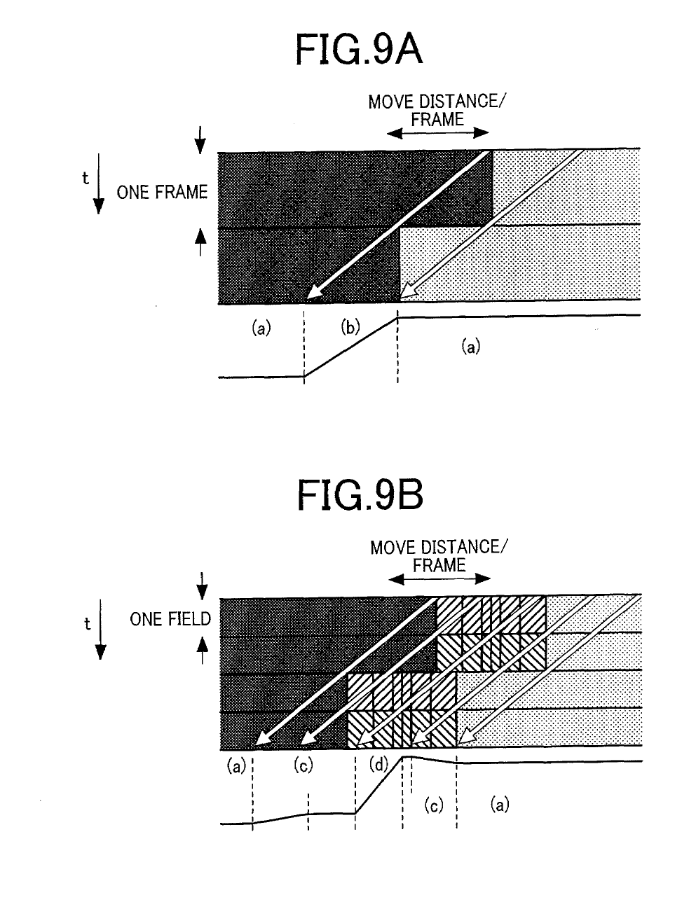

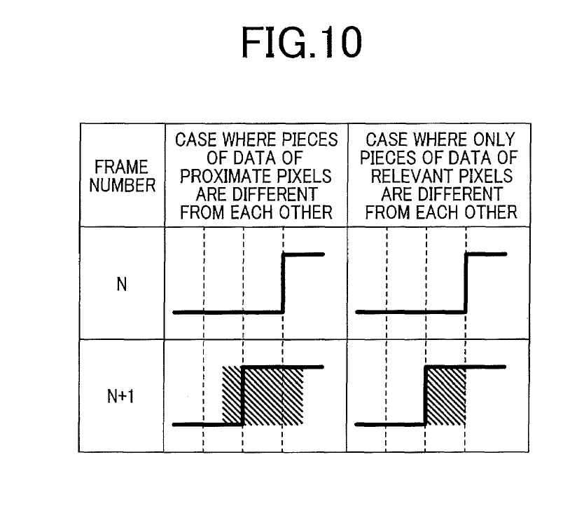

FIG. 4 is a flow chart for describing operation flows executed in the temporal direction data converting circuit 206 according to the first embodiment of the present invention. FIG. 5 is a flow chart for describing operation flows executed in the spatial direction data converting circuit 210 according to the first embodiment of the present invention. FIG. 6 is a diagram schematically illustrating a data conversion performed in the first embodiment of the present invention. FIGS. 7A and 7B are tables for describing examples of calculation parameters employed in the first embodiment of the present invention, namely, FIG. 7A illustrates an example of the temporal direction data calculation parameter, and FIG. 7B illustrates an example of the spatial direction calculation parameter. FIGS. 8A and 8B illustrate an example of an output image of display data which is acquired from the conversion result of the first embodiment of the present invention. FIGS. 9A and 9B are diagrams for describing a moving image characteristic obtained in the display apparatus according to the first embodiment of the present invention. FIG. 10 is a diagram for describing a relationship between conversion data and the temporal direction data coincident flag 207 according to the first embodiment of the present invention. Precisely speaking, FIG. 10 indicates luminance in respective frames, and hatched portions represent regions in which data is to be converted.

Referring now to FIGS. 4 to 10, operations of the display apparatus according to the first embodiment of the present invention will be described in detail. In response to the input control signal 102 input from the external system (not shown), the control signal producing circuit 103 produces the memory control signal 106 for controlling the frame doubler 108, the calculation control signal 107 for controlling the calculation parameter storing unit 111 and the calculating circuit 113, the column electrode control signal 104, and the row electrode control signal 105. The frame doubler 108 performs a writing operation of the input display data 101 corresponding to respective pixels of the matrix type display 119, which is transferred from the external system, based upon the memory control signal 106, and also performs a reading operation as the current frame display data 109 and the preceding frame display data 110.

The relationship among the input display data 101, the current frame display data 109, and the preceding frame display data 110 is given as illustrated in FIG. 3. That is, the frame doubler 108 performs the reading operation two times at a double speed (n=2) (double frequency) with respect to a time period (input frame period) from a head of a display region of a certain screen to another head of display region of the subsequent screen. In this case, it is assumed that a time period based upon a first half of read data is referred to as a first half field, and another time period based upon a second half of read data is referred to as a second half field with respect to one frame period. Further, it is assumed that both the current frame display data 109 and the preceding frame display data 110 have a phase difference of one frame as illustrated in FIG. 3.

Both the current frame display data 109 and the preceding frame display data 110, which have the above-mentioned timing, are transferred to the calculating circuit 113. The calculating circuit 113 has configuration as illustrated in FIG. 2, and the current frame display data 109 is transferred to the current frame analysis range deriving circuit 201. The current frame analysis range deriving circuit 201 is arranged by a latch circuit and a line memory circuit. As a consequence, current frame display data of an “m”th row and an “n”th column, in a matrix type display constituted by “M” rows (for example, 768 rows) and “N” columns (for instance, 1366×RGB columns) is assumed as DN(m, n). The current frame analysis range deriving circuit 201 outputs display data constructed of 2×I rows 2×J columns: DN(m−I, n−J) to DN(m+I, n+J), while the display data DN(m, n) is set as a center.

There are some cases where display data is not present, depending upon the values of “m” and “n”. In such a case, display data with respect to the existing display screen edge portion, namely, m=1 or “M”, otherwise n=1 or “N” may be applied. Similarly, the preceding frame display data 110 is processed by the frame analysis range deriving circuit 202, and hence display data constructed of 2×I rows 2×J columns: DP(m−I, n−J) to DP(m+I, n+J) is output by the preceding frame analysis range deriving circuit 202 with respect to the preceding frame display data “DP(m, n)” of the “m”th row and “n”th column. In this case, when I=1 and J=1 are given, a relationship between the display data (current frame) DN(m−I, n−J) to DN(m+I, n+J), and the display data (preceding frame) DP(m−I, n−J) to DP(m+I, n+J) is represented in FIG. 6.

With respect to the current frame display data 109 and the preceding frame display data 110 produced in the above-mentioned manner, data conversion is performed by the temporal direction data converting circuit 206. An algorithm of the temporal direction data converting circuit 206 is defined by a flow chart of FIG. 4. That is, with respect to the display data of the “m”th row and “n”th column, the temporal direction data converting circuit 206 compares current frame display data: DN(m+i, n+j) with preceding frame display data: DP(m+i, n+j) within such an analysis range that “i” is defined from “−I” to “+I”, and “j” is defined from “−J” to “J”. In this case, since it is not required to hold all of bit data to be displayed with respect to the preceding frame display data: DP(m+i, n+j), display data from which bit data has been deleted in a similar algorithm is also employed with respect to the current frame display data: DN(m+i, n+j).

As a result of the data comparison, when the current frame display data DN(m+i, n+j) is coincident with the preceding frame display data DP(m+i, n+j), in correspondence with the display data of the “m”th row and “n”th column, as time axis conversion data: DT(m+i, n+j) of a “+i”th row and “+j”th column from the display position thereof, the current frame display data: DN(m+i, n+j) of the relevant position is substituted, and a temporal direction data coincident flag: FLAG holds the logic level thereof. On the other hand, when the preceding frame display data DP(m+i, n+j) is not made coincident with the current frame display data DN(m+i, n+j), the temporal direction data coincident flag “FLAG” is set to a logic level “1”, and a data conversion is carried out by the temporal direction data converting circuit 206 in accordance with data amounts of both the current and preceding frame display data, and a value of the temporal direction calculation parameter 205. The temporal direction calculation parameter has different values, depending upon the first half field or the second half field.

For the sake of easier understanding, processings executed in the flow chart of FIG. 4 are described in separated manners, depending upon the first half field and the second half field. However, in the actual circuit, while the value of the temporal direction calculation parameter 205 is changed in the first half field and the second half field as illustrated in FIG. 3 according to the calculation control signal 107 illustrated in FIG. 1, the data conversion can be performed by the temporal direction data converting circuit 206. This temporal direction calculation parameter 205 is expressed as “ODO[i, j] (DN(m+i, n+j), DP(m+i, n+i))” in the first half field, and as “ODE[i, j](DN(m+i, n+i), DP(m+i, n+i))” in the second half field.

This expresses that the display data conversion is finally carried out with respect to the display data of the “m”th row and “n”th column, based upon the current frame display data of the “+i”th row and “+j”th column: DN(m+i, n+j) from the display position thereof, and the preceding frame display data: DP(m+i, n+j). More specifically, as an example of a case where i=0 and j=0, a table configuration indicated in FIG. 7A is obtained. For instance, in the case where the current frame display data DN(m, n) is equal to 192 and the preceding frame display data DP(m, n) is equal to 64, if the first half field is selected, a numeral “7” located at an intersection portion of both the current and preceding frame data is defined as a value of the temporal direction data conversion parameter “ODO[0, 0] (DN(m, n), DP(m, n))”, whereas if the second half field is selected, a numeral “−16” located at an intersection portion of both the current and preceding frame data is defined as a value of the temporal direction data conversion parameter “ODE [0, 0] (DN(m, n), DP(m, n))”. Although addition data have been set every 64 gradation in FIG. 7A, the addition data may be alternatively set among all of the gradation, or the addition data may be alternatively interpolated between one gradation and another gradation, which are not present as the table.

Further, although FIGS. 7A indicates only the case where i=0 and j=0, the values of the addition table may be properly changed in response to values of “i” and “j”, or the same values of the addition table may be alternatively set with respect to arbitrary “i” and “j” values. When the values of the addition table are changed in response to the values “i” and “j”, the values of the addition table can be set in higher precision correspondingly. In a case where the same addition values are set irrespective of the values “i” and “j”, the scale of the calculating circuit can be reduced, since a calculation result of “+i”th row and “+j”th column display data from a position where display data corresponding to “m”th row/“n”th column is produced becomes equal to a calculation result of “(+i+1)”th row/“+j”th column from this position where display data corresponding to “(m−1)”th row/“n”th column.

As illustrated in FIGS. 7A and 7B, in the above-mentioned calculations, in an odd field, when a change from the preceding frame display data “DP” to the current frame display data “DN” is positive, an adding operation is carried out based upon the table value with respect to the current frame display data “DN”, and conversely, when a change from the preceding frame display data “DP” to the current frame display data “DN” is negative, a subtracting operation is carried out based upon the table value with respect to the current frame display data “DN”. On the other hand, in an even field, when a change from the preceding frame display data “DP” to the current frame display data “DN” is positive, a subtracting operation is carried out based upon the table value with respect to the current frame display data “DN”, and conversely, when a change from the preceding frame display data “DP” to the current frame display data “DN” is negative, an adding operation is carried out based upon the table value with respect to the current frame display data “DN”.

The above-mentioned operations are carried out with respect to a range defined by 2I×2J. As a result of the above-mentioned calculations, the temporal direction conversion data 208 constructed of the range defined by 2I×2J, and the temporal direction data coincident flag 207 are produced in order to produce display data of the “m”th row and “n”th column. As a result of the above-mentioned calculations, within the analysis range, if all pieces of display data are coincident with each other in both the preceding frame and the current frame, the temporal direction data coincident flag 207 becomes a logic level “0”, whereas if all pieces of display data are not coincident with each other in both the preceding frame and the current frame, the temporal direction data coincident flag 207 becomes a logic level “1”.

The temporal direction data coincident flag 207 and the temporal direction conversion data 208, which have been produced in accordance with the above-mentioned operations, are transferred to the spatial direction data converting circuit 210 so as to perform a data conversion based upon the spatial direction calculation parameter 209, thereby producing the temporal/spatial conversion display data 114.

The above-mentioned conversion algorithm is illustrated as a flow chart of FIG. 5. Firstly when the temporal direction data coincident flag 207 is the logic level “0”, this flag 207 implies that there is no different display data among the frames within the analysis range. In this case, as temporal/spatial direction conversion display data: DS(m, n) of the “m”th row and “n”th column, temporal direction conversion display data: DT(m, n) is transferred, which corresponds to the display data of the “m”th row and “n”th column. In this case, since the data conversion is not performed in the above-mentioned temporal direction data converting circuit 206, the temporal/spatial direction conversion display data DS(m, n) has the same value as that of the input display data “DN(m, n)”.

On the other hand, when the temporal direction data coincident flag 207 is the logic level “1”, a convolution operation is performed between a conversion parameter: CVO(DTO(m, n), i, j) made of a matrix structure (2×I rows 2×J columns) when the first half field is selected, and temporal direction data conversion data : DTO(m−i, n−j) of the first half field, made of the same matrix structure (2×I rows 2×J columns), thereby producing temporal/spatial conversion display data: DS(m, n). In this case, the conversion parameter CVO(DTO(m, n), i, j) corresponds to a value determined based upon temporal direction data conversion data DTO(m, n) of an analysis pixel, and a positional relationship “i” and “j” of this analysis pixel. More specifically, the conversion parameter CVO(DTO(m, n), i, j) constitutes a table as illustrated in FIG. 7B. The table of FIG. 7B is an example of I=2 and J=2, resulting in a high range emphasized filter.

Similarly, when the second half field is selected, a convolution operation is carried out between a conversion parameter: CVE(DTE(m, n), i, j) and a temporal direction data conversion data DTE(m−i, n−j) of the second half field, thereby producing temporal/spatial conversion display data: DS(m, n). In this case, similar to the case of the first half field, the conversion parameter CVE(DTE(m, n), i, j) is constituted by such a table determined by “DTE(m, n)”, “i”, and “j”. More specifically, the conversion parameter CVE(DTE(m, n), i, j) is given as such a table illustrated in FIG. 7B, resulting in a low range emphasized filter.

The temporal/spatial conversion display data 114 produced in accordance with the above-mentioned operations is transferred to the matrix type display 119, and thus, the matrix type display 119 performs a data display operation based upon the above-mentioned temporal/spatial direction conversion display data “DS (m, n)” converted from the input display data “DN(m, n)” with respect to the display data of the “m”th row and “n”th column.

The above-mentioned data conversion is summarized as follows. As illustrated in FIG. 6, with respect to the data of the “m”th row and “n”th column, the data conversion is performed along the temporal direction based upon the respective values of the preceding frame data: DP(m−I, n−J) to DP(m+I, n+J) in which the pixel position thereof is set as the center, the respective values of the current frame data: DN(m−I, n−J) to DN(m+I, n+J), and the conversion parameters which are different from each other for each field. As a result of this data conversion, the temporal direction conversion data: DT(m−I, n−J) to DT(m+I, n+J) are produced, and thereafter, the convolution operation is executed based upon the produced temporal direction conversion data and the conversion parameters which are different from each other for each field in order to perform the data conversion along the spatial direction, thereby producing the temporal/spatial direction conversion data: DS(m, n).

As a result of the above-mentioned operations, if there is no change in the display data of the proximate pixels between frames, the temporal/spatial direction conversion data 114 becomes equal to the input display data 101. As a consequence, when the still image is displayed, the display quality of the still image equivalent to the conventional display quality can be maintained. To the contrary, a case where video display data is changed between frames is illustrated in FIGS. 8A and 8B.

FIG. 8A is an illustration when the screen of the matrix type display 119 is monitored, namely, represents that with respect to a background region meshed in dark lines, a region meshed in light lines move from a right side of the screen to a left side thereof along a horizontal direction. In this case, in a case where a center portion of the screen is illustrated along the horizontal direction, as indicated in FIG. 8B, as a frame number is increased, edge portions having different illuminances move. In contrast to the above-mentioned example, when the driving system according to the first embodiment is performed, while the edge portion is set as a center, such an image in which a difference of images has been emphasized along both the temporal direction and the spatial direction is displayed in the odd field, whereas such an image in which a difference of images has been reduced along the temporal direction and the spatial direction is displayed in the even field.

The resultant influences on the displays are indicated in FIGS. 9A and 9B. When an input image is directly displayed, even if a response time of a matrix type display is zero, a line of sight indicated by inclined arrows (white arrows) of FIG. 9A is traced, and hence a blurring width corresponding to a region indicated by a double-arrow line of FIG. 9A is produced in response to a move distance between the frames. On the other hand, in the first embodiment, as indicated in FIG. 9B, an output image has luminance of a hatched portion, which is different from the luminance of the input image. In this case, in a region (a) of FIG. 9B, since the display data is not changed, this region (a) has similar luminance to that of a region (a) of FIG. 9A.

In contrast to the above-mentioned region, in a region (c) illustrated in FIG. 9B, luminance thereof is being changed. This luminance change is caused by the display data conversion along the temporal direction and the spatial direction. The changing ratio of luminance becomes gentle, since the emphasized high range of the first half field is offset by the emphasized low range of the second half field. In contrast to the above-mentioned region, in a region (d) illustrated in FIG. 9B, a luminance change related to the emphasized high range of the second half field is monitored as an edge. A viewer can hardly judge whether or not any edge is present in the region (c) of FIG. 9B, and a luminance change related to a video whose low range in the first half field has been emphasized, whereas the viewer can recognize only the luminance change in the high range. As a consequence, a blurring width becomes an area of a region (d) illustrated in FIG. 9B. Since this blurring area of the region (d) illustrated in FIG. 9B is smaller than that of the region (b) illustrated in FIG. 9A, the viewer can finally recognize the input image as a desirable video having a smaller blurring component.

It should be noted that although the range for calculating the temporal direction data coincident flag 207 has been set equal to the data conversion range for one pixel in the spatial direction data converting circuit 210 corresponding to the subsequent step in the first embodiment, the present invention is not limited to the above-mentioned calculation range. For instance, the present invention may alternatively employ a method for calculating the temporal direction data coincident flag 207 by only comparing the current frame display data 203 with the preceding frame display data 204 in the relevant pixel, or a range between those display data 203 and 204. In this alternative case, a range where the input display data 101 is different from the temporal/spatial conversion display data 114 becomes such a different data example as illustrated in FIG. 10. However, according to evaluated results made by the Inventors of the present invention, in a case where a signal which originally has low resolution and a low S/N ratio, for example, an NTSC signal, is enlarged to be displayed on a display having high resolution, it is desirable to produce the temporal direction data coincident flag 207 by comparing one pixel only with each other. When a high definition television signal is displayed, if the temporal direction data coincident flag 207 is produced from a wider range, a desirable high display quality can be achieved.

As previously described, according to the first embodiment, while the display quality as to the still image is not deteriorated, the moving image blurring that occurs when the moving image is displayed can be lowered by employing the simple circuit configuration of the display apparatus.

### Second Embodiment

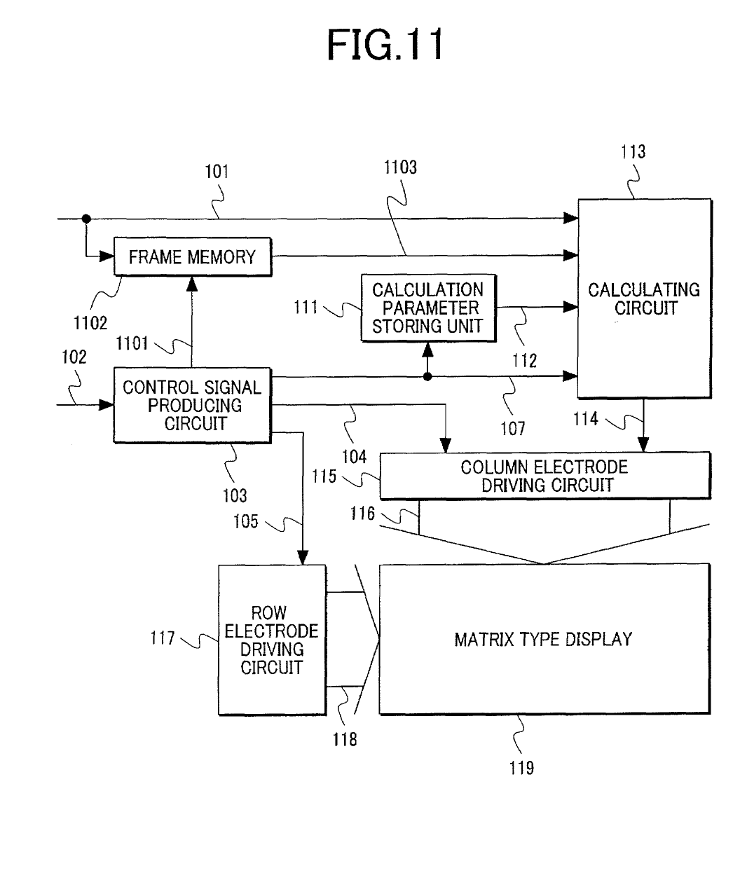

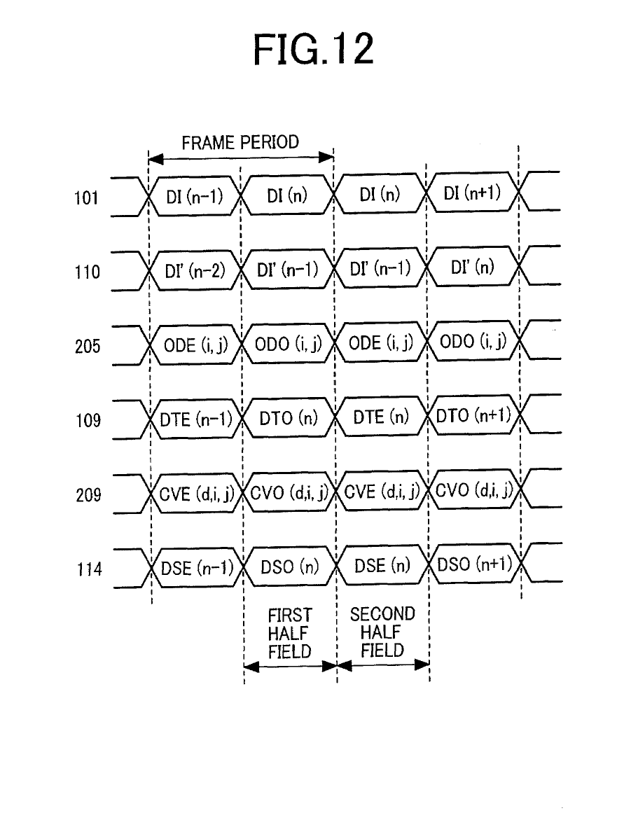

Next, a description is made of a second embodiment of the present invention with reference to FIGS. 11 and 12. In the second embodiment, input display data 101 is directly displayed without converting a memory readout frequency with respect to the input display data 101. FIG. 11 is a block diagram illustrating configuration of a display apparatus according to the second embodiment of the present invention. The same reference numerals illustrated in the above-mentioned first embodiment is employed for denoting structural elements of the second embodiment, which have similar functions to those of the first embodiment, although timing specifications thereof are different from those of the first embodiment. In FIG. 11, reference numeral 1101 denotes a memory control signal; 1102, a frame memory; and 1103, preceding frame display data. FIG. 12 illustrates a timing chart representing time sequential operations after the display data 101 is input until the display data 101 is processed in a column electrode driving circuit 115 with respect to the display apparatus of the second embodiment. A detailed description is made of operations of the display apparatus according to the second embodiment with reference to FIGS. 11 and 12.

The input display data 101 input from an external system is processed so as to perform a data writing operation and a data reading operation in response to a memory control signal 1101. The memory control signal 1101 is produced in a control signal producing circuit 103 based upon a control signal 102 which is also input from the external system. In the first embodiment, the data is read at the speed two times higher than the writing speed by employing the frame doubler 108. In the second embodiment, as illustrated in FIG. 12, a data reading operation is performed at the same speed as a data writing speed by employing a frame memory 1102. In this case, a scanning speed of a matrix type display 119 becomes equal to a scanning speed of an input. In addition to the frequency of 60 Hz, the frequency of 120 Hz, and other frequencies cause no problem.

Similarly, in accordance with the second embodiment, the moving image blurring that occurs in displaying of the moving image can be lowered by employing the simple circuit arrangement without deteriorating the display quality of the still image.

### Third Embodiment

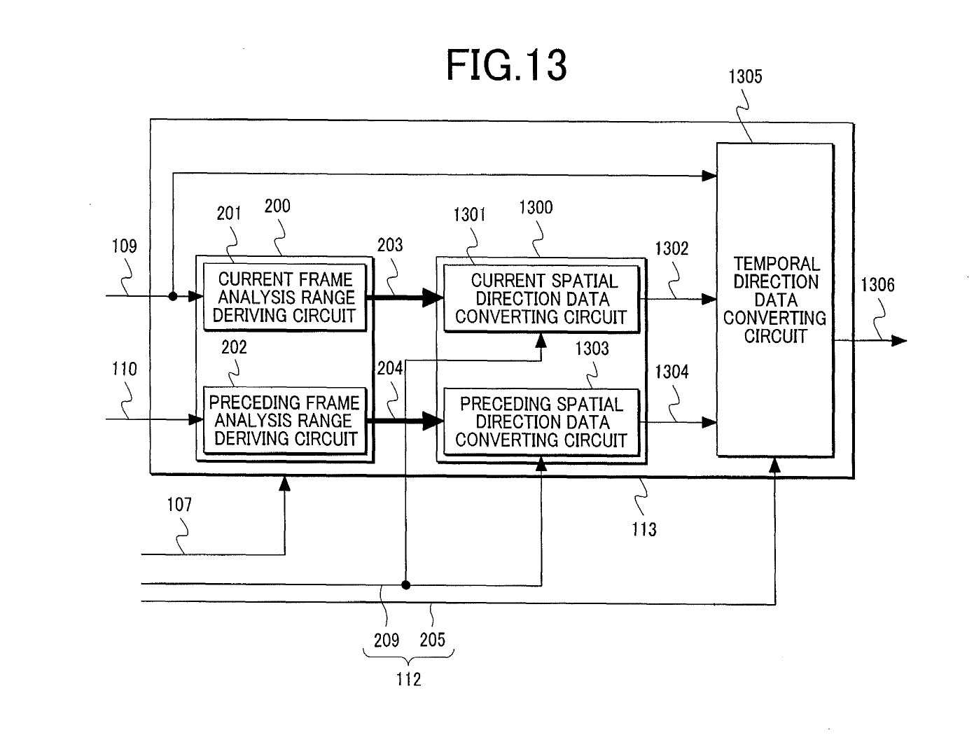

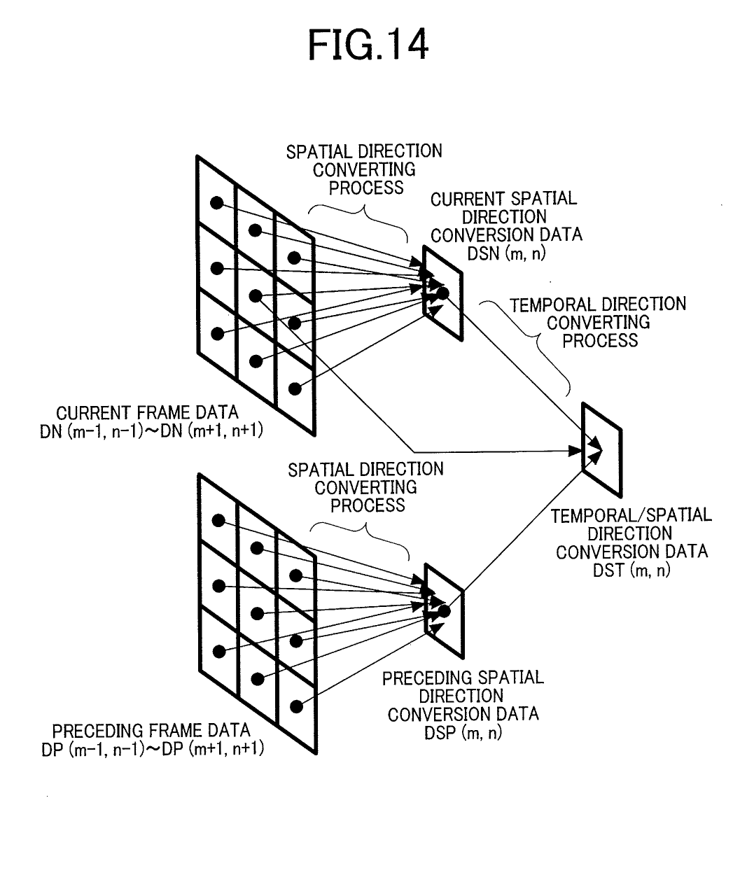

As a third embodiment of the present invention, another example of a case where a calculating method different from that of the first embodiment is employed is described with reference to FIGS. 13 and 14. FIG. 13 is a block diagram illustrating configuration of a calculating circuit 113 provided according to the third embodiment of the present invention. In the case where structural elements of the third embodiment have similar functions to those of the first embodiment, the same reference numerals illustrated in the first embodiment are employed even if timing specifications or the like are different from those of the first embodiment of the present invention. In FIG. 13, reference numeral 1300 denotes a spatial direction data converting circuit; 1301, a current spatial direction data converting circuit; 1302, current spatial direction conversion display data produced by the current spatial direction data converting circuit 1301; 1303, a preceding spatial direction data converting circuit; 1304, preceding spatial direction conversion display data produced by the preceding spatial direction data converting circuit 1303; 1305, a temporal direction data converting circuit; and 1036, spatial/temporal direction conversion data produced by the temporal direction data converting circuit 1305. FIG. 14 is a diagram illustrating an outline of data conversion performed in the third embodiment.

With reference to the above-mentioned drawings, a description is made of the configuration and operations of the display apparatus according to the third embodiment. First, current frame display data 109 is processed by a current frame analysis range deriving circuit 201 so as to produce current frame derive data 203, and preceding frame display data 110 is processed by a preceding frame analysis range deriving circuit 202 so as to produce preceding frame derive data 204. The above-mentioned operations are identical to those of the first embodiment.

Next, the current frame derive data 203 and the preceding frame derive data 204 are processed by the current spatial direction data converting circuit 1301 and the preceding spatial direction data converting circuit 1303 so as to produce the current spatial direction conversion display data 1302 and the preceding spatial direction conversion data 1304, respectively, based upon conversion parameters which are different from each other for every field. Since algorithms and the conversion parameters of the current spatial direction data converting circuit 1301 and the current spatial direction conversion display data 1302 are equivalent to each other, when display data are not changed between frames, outputs thereof become equal to each other.

The temporal direction data converting circuit 1305 performs conversion of the temporal directions among the current spatial direction conversion data 1302 and the preceding spatial direction conversion data 1304 which have been produced in the above-mentioned manner and the current frame display data 109 so as to produce the spatial/temporal direction conversion data 1306. In this case, when the current spatial direction conversion data 1302 is coincident with the preceding spatial direction conversion data 1304, the spatial/temporal direction conversion data 1306 outputs the current frame display data 109. To the contrary, when the current spatial direction conversion data 1302 is not coincident with the preceding spatial direction conversion data 1304, between the current spatial direction conversion data 1302 and the preceding spatial direction conversion data 1304 based upon the algorithm of the temporal direction data converting circuit 210, which is described in the first embodiment, the spatial/temporal direction conversion data 1306 produces spatial/temporal direction conversion data 1306. Then, the produced spatial/temporal direction conversion data 1306 is transferred to the matrix type display 119 so as to be displayed.

The conceptional idea described above is illustrated in FIG. 14. That is, first, with respect to current frame display data and preceding frame display data, display data constructed in a matrix form, which are located in the vicinity of the relevant pixel, are processed by a spatial direction converting processing so as to produce conversion data of the relevant pixel. Then, based upon the respective items of spatial direction converted data, spatial/temporal direction conversion data is produced.

As in the first embodiment, in the operations of the third embodiment described above, the moving image performance when the video is moved between the frames can be improved while maintaining the display quality equivalent to that of the input image when the still image is displayed.

When the present invention is applied, in a matrix type display apparatus having a display characteristic as that of a liquid crystal display apparatus, moving image blurring that occurs when a moving image is displayed can be reduced while maintaining a display quality of a still image. As a consequence, the present invention can be similarly applied to a television receiver equipped with a liquid crystal display panel, a display monitor provided in a personal computer, and further a cellular telephone, a game machine, or the like. In addition, the present invention can be applied not only to a hold type display such as an organic electroluminescence (EL) display in which an organic EL element is used for a light emitting device of a pixel portion, and a liquid crystal on silicon (LCOS) display in which a control element of a pixel portion is used under a reflection layer, but also to a plasma display panel (PDP) or the like.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

What is claimed is:

1. A display apparatus of a matrix type, comprising:
a display having a screen in which a plurality of pixels are arranged along a row direction and a column direction of a matrix form, which performs gradation display by changing luminance of the screen in accordance with input display data;
a memory for storing there into display data for at least one frame, from which the input display data written in the memory is read for “n” frames at speed “n” times higher than writing speed; and
a calculating circuit for calculating a change in the input display data read “n” times along a temporal direction and a spatial direction, wherein:
when a time period during which display data for one screen is transferred from an external system is defined as one input frame period and another time period during which the display data for the one screen of the display is rewritten is defined as one rendering frame period:
in a case where pieces of display data of proximate pixels for each of a pixel of display data in a preceding input frame and a pixel of display data in a current input frame as to the display data input from the external system within the one input frame period are substantially coincident with each other, the calculating circuit directly outputs the display data input from the external system in accordance with a gradation requested by the external system to the display as display data within the one input frame period; and
in a case where the pieces of the display data of the proximate pixels related to the each of the pixel of the display data in the preceding input frame and the pixel of the display data in the current input frame as to the display data input from the external system within the one input frame period are not coincident with each other, the calculating circuit outputs display data of “n” rendering frames to the display with in the one input frame period, the “n” rendering frames including a rendering frame in which the display data has been converted so as to emphasize a temporal change and a spatial change of the display data, and another rendering frame in which the display data has been converted so as to deemphasize the temporal change and the spatial change of the display data, in accordance with the display data of the proximate pixels among the respective “n” frames, which have been read “n” times.

2. A display apparatus according to claim 1, wherein the one rendering frame period has a repetition frequency of 24 Hz or higher.

3. A display apparatus according to claim 1, further comprising:
a memory for holding display data for at least one frame period;
an analysis range deriving circuit for deriving display data of the proximate pixels for at least two frame periods;
a temporal direction data converting circuit for one of emphasizing and deemphasizing respective pieces of the display data of the proximate pixels for the at least two frame periods in accordance with the change along the temporal direction from video data for two frame periods; and
a spatial direction data converting circuit for one of emphasizing and deemphasizing, the one of emphasized and deemphasized display data in accordance with a change along the spatial direction.

4. A display apparatus according to claim 1, further comprising:
a memory for holding display data for at least one frame period;
an analysis range deriving circuit for deriving display data of the proximate pixels for at least two frame periods;
a spatial direction data converting circuit for one of emphasizing and deemphasizing respective pieces of the display data of the proximate pixels for the at least two frame periods in accordance with the change along the spatial direction from video data for two frame periods; and
a temporal direction data converting circuit for one of emphasizing and deemphasizing, the one of emphasized and deemphasized display data in accordance with a change along the temporal direction.

5. A display apparatus according to claim 3, wherein the temporal direction data converting circuit adds an output obtained based upon a difference in the display data for the at least two frame periods derived by the analysis range deriving circuit to one of a current frame and a preceding frame, and subtracts the output from another one of the current frame and the preceding frame.

6. A display apparatus according to claim 5, wherein the spatial direction data converting circuit removes a low frequency component of the display data for one of the at least two frame periods derived by the analysis range deriving circuit, and removes a high frequency component of the other display data for another one of the at least two frame periods.

7. A display apparatus, comprising:
a dividing circuit for dividing input display data for one frame into display data for a plurality of fields;
a calculating circuit for adding first correction data produced based on a difference in display data among a plurality of frames to the divided display data for at least one field of the plurality of fields, and for subtracting second correction data produced based on the difference in the display data among the plurality of frames from the divided display data for at least another field of the plurality of fields; and
a display panel for displaying the display data for the plurality of fields.

8. A display apparatus according to claim 7, wherein the calculating circuit removes a low frequency component of the divided display data for the at least one field to which the first correction data has been added, and also removes a high frequency component of the divided display data for the at least another field from which the second correction data has been subtracted.

9. A display apparatus according to claim 8, wherein the calculating circuit removes the low frequency component of the divided display data for the at least one field using a high-pass filter, and also removes the high frequency component of the divided display data for the at least another field using a low-pass filter.

10. A display apparatus according to claim 7, wherein:
the dividing circuit divides the input display data for one frame into display data of two frames; and
the display panel alternately displays the divided display data for two frames.

11. A display apparatus according to claim 7, further comprising:
a dividing circuit for dividing the input display data for one frame into display data for a plurality of fields;
a calculating circuit for removing a low frequency component of the divided display data for at least one field of the plurality of fields, and for removing a high frequency component of the divided display data for at least another field of the plurality of fields; and
a display panel for displaying the divided display data of the plurality of fields.
